(19) United States
(12) Patent Application Publication
(10) Pub. No.: US 2008/0099350 A1
(43) Pub. Date: May 1, 2008

(54) Storage Box And Rack

(76) Inventor: Gilbert Duncan, Aberdeen (GB)

Correspondence Address: KED & ASSOCIATES, LLP, P.O. Box 221200, Chantilly, VA, 20153-1200, US

(21) Appl. No.: 11/663,655

(22) PCT Filed: Sep. 22, 2005
(86) PCT No.: PCT/GB05/03666

§ 371 Date: Mar. 23, 2007

(30) Foreign Application Priority Data
Sep. 24, 2004 (GB) 0421270.0

(51) Int. Cl. B68C 1/00; G08B 13/14; F16B 47/00

(52) U.S. Cl. 206/216; 211/85.11; 70/69; 340/568.1; 116/99

(57) ABSTRACT

A saddle rack (1a) and system for storing equestrian equipment. The saddle rack (1a) may include suction cups (24) for attaching the rack (1a) to a suitable surface. In one embodiment, the suction cups (24) have quick-release mechanisms enabling the rack (1) to be easily moved and attached to surfaces in different locations. They may also allow rotation of the saddle rack (21), which may have an anatomic form. The system includes a container (3) within which, in one embodiment, the saddle rack (1a) may be located and stored. The saddle rack (1a) may also be attached to an exterior surface of the container (3). This container (3) or box may be provided with handles (8a, 8b) or wheels (12a, 12c) to transport the saddle rack (1a) and other horse tack as required.

The present invention relates to an equestrian luggage system for organisation, storage, and transportation of equestrian equipment.

Typical equestrian luggage ranges consists of a number of bags and cases designed specifically for individual items of equipment including horse tack. Another approach to transporting horse tack has been through the use of tack trunks. Tack trunks are designed for transportation of a plurality of items including saddles, bridles, boots, and brushes. Trunks are traditionally made from wood or heavy plastic materials and usually contain a compartmentalised interior structure.

However, although trunks offer storage of many items, there have been identified limitations of current tack trunk storage systems. Wooden trunks used outdoors are susceptible to retaining water within the wood causing damp build-up within the storage trunk. Current trunks are, typically, cumbersome and difficult to manoeuvre due to designs incorporating angular features, combined with the use of relatively heavy construction materials. As current systems offer storage of a large number of items within a limited amount of space, actual physical protection of individual items is limited and may be compromised. Proper storage of leather equestrian equipment is of paramount importance for repeated use and long-term preservation of the equipment. It is also important to be able to place a saddle rack in a convenient and easily accessible location in order to properly maintain the saddle. Tack trunk systems have limited means of supporting such functionality.

It is an aim of the present invention to provide a saddle rack and container for equestrian equipment that obviates, or at least mitigates, the drawbacks and deficiencies of the prior art.

It is an aim of an aspect of the present invention to provide a system for encapsulation of horse tack for storage and transport, incorporating safe, protective, and convenient means for storage and maintenance of a saddle.

It is an aim of an aspect of the present invention to provide a saddle rack, which can be positioned inside a box for transporting a saddle, or, which can be attached in locations convenient for maintenance of a saddle.

It is a further aim of an embodiment of the present invention that the saddle rack supports long-term use of a saddle through a design that will minimise damage to the saddle and prevent harm to a horse.

Furthermore, it is an aim of an embodiment of the present invention to provide a horse tack transportation container that is lightweight, hard-wearing, and water resistant by manufacture, for example, by using composite materials.

According to the first aspect of the present invention there is provided a saddle rack comprising attachment means for attachment to an attachment surface, characterised in that the attachment means are suction cups.

Preferably, the suction cups are operated via a quick-release lever mechanism.

Preferably, the suction cups allow rotation of the saddle rack relative to the attachment surface.

Preferably, the saddle rack is constructed from a composite material.

Preferably, the saddle rack has an anatomic form.

Preferably, the anatomic form is that of the saddle bearing part of the back of a horse.

Preferably, the saddle rack comprises at least one storage compartment for containing equestrian equipment.

According to the second aspect of the present invention there is provided a portable container adapted to accommodate a saddle rack, characterised in that the container provides an attachment point for a saddle rack.

Preferably, the container is moulded from a plastic or composite material.

Preferably, the container provides an attachment point for a saddle rack in accordance with the first aspect of the invention.

Optionally, the attachment point is on an inner surface of the container.

Optionally, the container provides a second attachment point on an outer surface of the container.

Preferably, the container comprises a main body and lid.

Preferably, the container lid is attached to the container main body by hinges.

Preferably, the lid is supported by gas-assisted struts.

Preferably, the container has security means.

Optionally, the security means is a code lock device.

Optionally, the security means is a key locking device.

Optionally, the security means is a micro chip identification device.

Optionally, the security means is a ring for attaching a security lanyard.

Optionally, the security means incorporates an alarm system.

Preferably, the alarm system is motion sensitive.

Preferably, the container is constructed from composite materials.

Preferably, the container has handling means.

Optionally, the handling means are handles.

Alternatively, or in addition, the handling means is a wheeled trolley.

Preferably, the trolley contains caster wheels.

Preferably, attachment means are provided for attaching the trolley to the container.

Preferably, the attachment means are suction cups.

Preferably, the suction cups have quick release mechanisms.

Preferably, the container defines a storage space adapted to incorporate a saddle rack.

Optionally, the storage space can contain a plurality of saddle racks.

Preferably, said storage space has dimensions sufficient to encapsulate at least one saddle and other horse tack.

According to a third aspect of the present invention there is provided a system for storing equestrian equipment, the system comprising a saddle rack, a container adapted to receive the saddle rack, and attachment means for allowing attachment of the saddle rack to the container.

Preferably, the saddle rack is a saddle rack in accordance with the first aspect of the invention.

Preferably, the container is a container in accordance with the second aspect of the invention.

According to a fourth aspect of the present invention there is provided a system for storing equestrian equipment, the system comprising a saddle rack, a container adapted to receive the saddle rack, and attachment means for allowing attachment of the saddle rack to the container, characterised in that the attachment means comprises one or more suction cups.

Preferably, the saddle rack is a saddle rack in accordance with the first aspect of the invention.

Preferably, the container is a container in accordance with the second aspect of the invention.

Preferably, the container provides an attachment surface for attaching the saddle rack to the container.

Preferably, the attachment surface is a smooth surface

Preferably, the attachment surface is a non-porous surface.

Example embodiments will now be described with reference to the following figures:

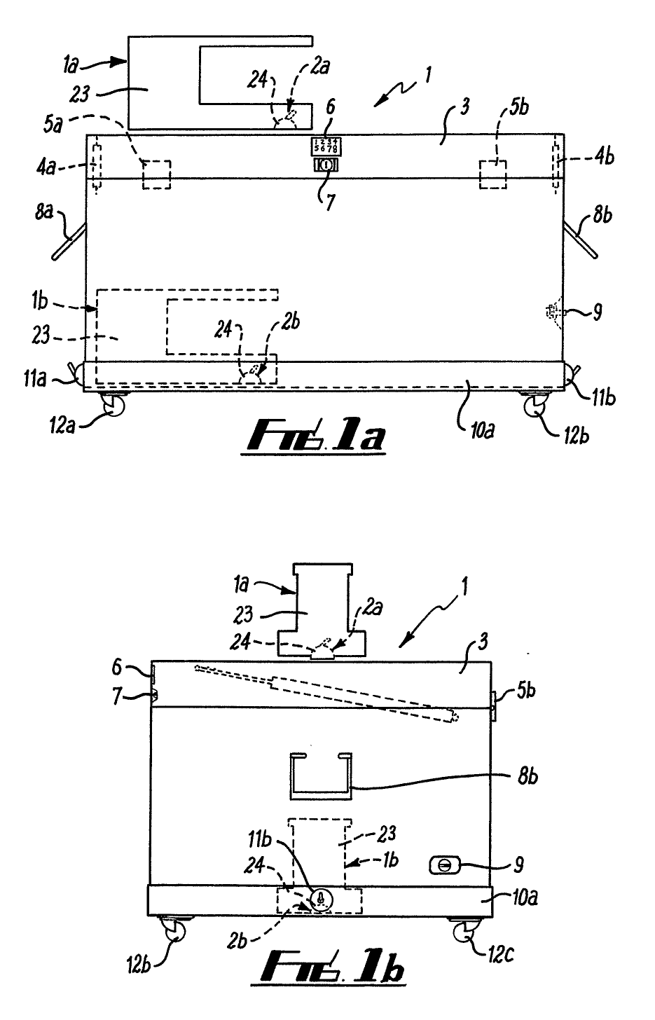

FIG. 1a is an illustration of a saddle rack and storage container according to an embodiment of the invention viewed side on;

FIG. 1b is an illustration of a saddle rack and storage container according to an embodiment of the invention viewed end on;

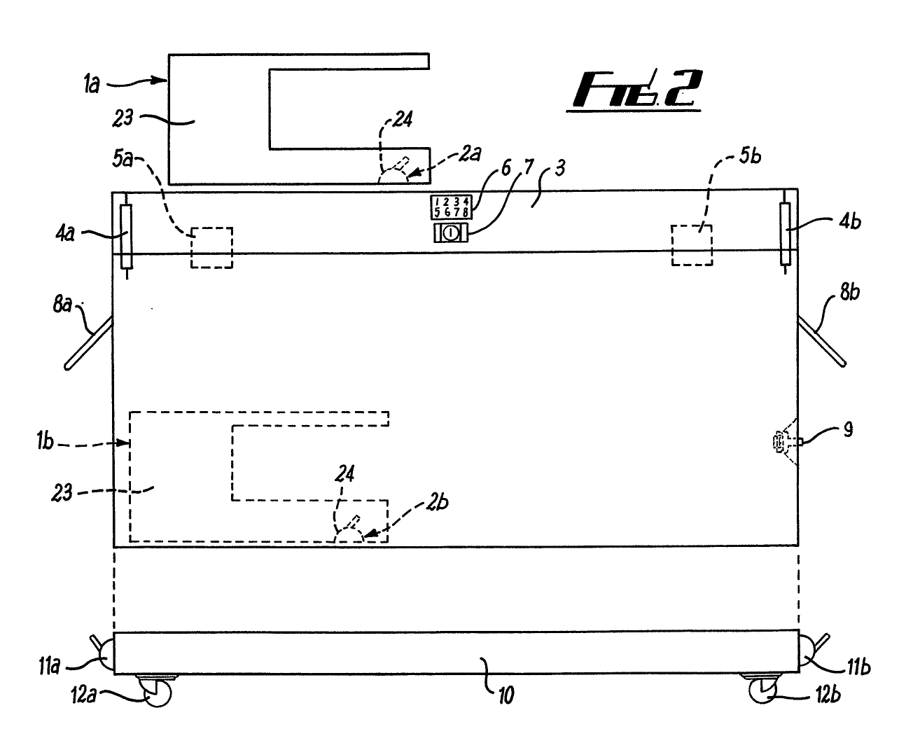

FIG. 2 is an illustration of a saddle rack and storage container with removable trolley according to an embodiment of the invention;

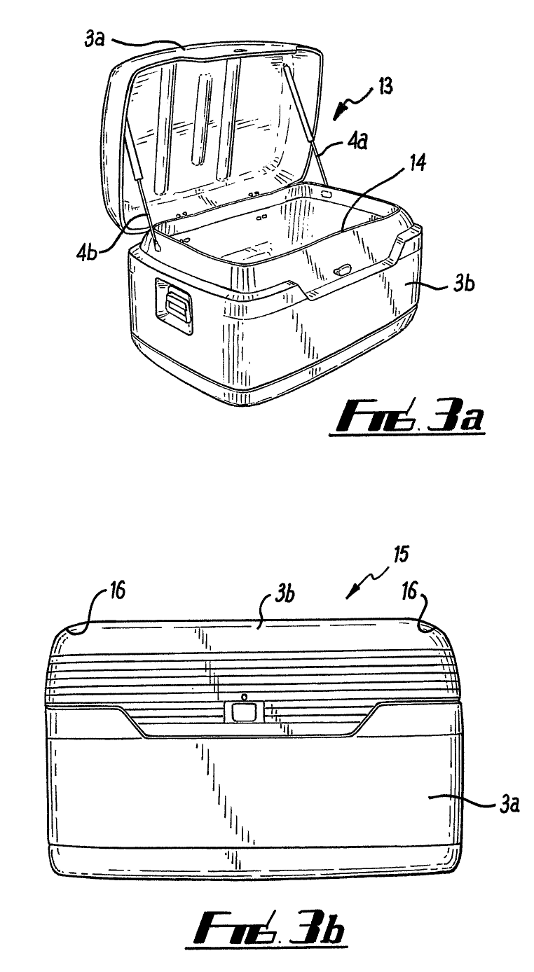

FIG. 3a is an illustration of a saddle rack and storage container with lid open according to an embodiment of the invention;

FIG. 3b is an illustration of a saddle rack storage container exterior according to an embodiment of the invention;

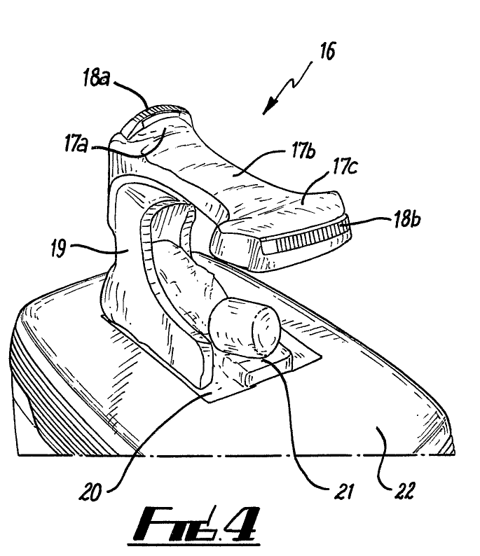

FIG. 4 is an illustration of an ergonomic saddle rack according to an embodiment of the invention.

With reference firstly to FIGS. 1a and 1b, a saddle rack and storage container is generally depicted at 1. The apparatus 23 is a saddle rack manufactured and moulded from fibre glass material and is depicted at positions 1a and 1b. It is understood that different formable composite materials, which may have improved durability or strength characteristics, may be used in other embodiments of the invention. The base of the saddle rack has an attachment point. The attachment of the apparatus 23, to an attaching surface, is by means of suction cups 24. In FIG. 1a, the saddle rack 23 is connected by means of suctions cups 24, in their respective positions 1a and 1b and positions 2a and 2b, to a storage container 3. Suction cups 24 have quick-release mechanisms, which allow attachment of the saddle rack 23 to the exterior surface of the container 3 and to the interior surfaces of the container 3. The suction cups 24 consist of a ridged hemispherical shell, which is manufactured to attach and reside in the fibre glass structure of the saddle rack 23. A semi-flexible disc is attached to the flat surface of the hemispherical shell of the suction cups together with a lever arm on the opposing curved surface of the shell.

The suction cups allow attachment to the surface by depression of the lever handle against the shell creating a vacuum between the disc and the attachment surface. The suction cups may be released by raising the handle in an easy release fashion. The suction cups 24 provide attachment means to allow attachment to smooth non-porous surfaces. The suction cups 24 feature an enclosed operational mechanism, which allows rapid attachment and re-attachment using the suction cups. The simple lever action allows the suction cups 24 to be operated comfortably in adverse conditions. In addition, their construction allows them to be easily wiped clean to ensure proper connection to the attachment surface whenever required.

The storage container 3 is manufactured from glass fibre and consists of a main body and lid. The container lid is supported by gas-assisted struts 4 and hinges 5, which allow for smooth opening of the storage container 3. The storage container 3 also comprises an alarm system, which has an alarm activation keypad 6. Further theft prevention measures are provided by a key-operated locking device 7. In other embodiments, the locking device 7 may be or may include a remote-operated locking/unlocking mechanism. Lifting handles 8 are attached to the main body of the storage container 3 to allow easy manipulation of the storage container. A ring 9 is mounted to the storage container 3 for attachment of a security lanyard. The container 3 resides on a trolley 10a, which is attached to the container 3 through easy-release suction cups 11a and 11b similar to those described at 24, and has a set of caster wheels 12a, 12b and 12c.

In an alternative embodiment, depicted in FIG. 2, the container 3 is allowed to be free standing by removing the trolley from a position 10a to a position 10b through the quick-release mechanism of the suction cups 11a and 11b. The trolley, which is optionally attachable to the storage container 3, provides a means for easy transportation by wheeling the container 3 to a location desired by the user. The option of attaching a trolley easily through the suction cups 11a and 11b, allows the container to be detached and stored on a flat surface, for example, in a motor vehicle, or, for example, for general usage in terrain that is otherwise unsuitable for proper functioning of trolley caster wheels 12a, 12b, and 12c. Removal of the trolley allows the overall height of the container to be reduced, thus, allowing the container to be stored in tight spaces.

An alternative embodiment of the invention is highlighted in FIG. 3a, which depicts a saddle rack container at 13. The container is manufactured from smooth fibre glass for ease of suction pad attachment of saddle rack and trolley to the container 3, as described in the above example embodiments.

Gas-assisted struts 4a and 4b, allow wide opening of container lid 3a and easy access to container 3b contents. Composite material is formed to achieve thin container walls 14, which provides favourable space and weight characteristics. FIG. 3b demonstrates gently rounded edges 16 of the storage container 15, which make for safe manual handling.

FIG. 4 depicts an example embodiment of the saddle rack in use. The saddle rack 16 has a top surface 17, which consists of a first end section 17a, a mid-section 17b, and a second end section 17c. The end sections 17a and 17c are formed to be slightly wider than the mid-section 17b. The top surface 17 has a longitudinal dimension that extends from the first end section 17a, through the mid-section 17b, to the second end section 17c. A top surface 17 latitudinal dimension transects the longitudinal dimension at right angles. The top surface is formed to be concave longitudinally whilst it is convex latitudinally, in order to replicate the saddle bearing part of a horse's back. The shape and dimensions of the top surface 17 will be suitable for a range of saddle sizes and shapes. Handles 18a and 18b are placed at the two end sections 17a and 17c for ease of lifting and manipulation of the saddle rack 16. The anatomic top surface 17 is attached by a support structure 19 to a base 20. The base 20, is hollow and incorporates space for storage 21 of other items such as the user's gloves, shoes, or hat. In this embodiment, the saddle rack is attached to the top of the container 22 for convenience of use.

In a further example embodiment demonstrating the use of the saddle rack 23 and container 3, the saddle rack is released from it's storage position within the container by operating the lever mechanism of the quick-release suction cups 24, and lifted, for example, with the saddle resting on the saddle rack, using saddle rack handles 18a and 18b to place the saddle rack onto the top of the container. In this example embodiment, the saddle rack is attached to the smooth top surface of the container and is reattached by depressing the suction cup lever mechanism, which, once attached, allows rotation of the saddle rack relative to the top of the container 3. Rotation of the saddle rack about the attachment point is carried out such that the rack overhangs the side of the container in a manner that allows maintenance and cleaning of the saddle away from the container and over the ground. In alternative embodiments, the saddle rack may be attached in a similar fashion in a location that provides a good height for maintaining the saddle, for example, on a car bonnet.

It should be understood that the saddle rack as outlined in the embodiments above may be attached to other smooth surfaces via rotatable quick-release suctions pads or simply as a free-standing saddle rack apparatus.

The present invention provides a convenient and non-destructive system for maintaining and storing a saddle together with a range of other horse tack. In this system, the saddle rests on a saddle rack, which is designed to cause minimum damage to the saddle and as a result should prevent harm to the horse. The saddle rack may be stored inside the container through a suction pad device which allows the user to position the rack and the saddle as required within the container for storage. Alternatively, the saddle and saddle rack may be attached to the outside of the container or to any other flat smooth non-porous surface that may be required for general maintenance of the saddle. The suction cap attachment device allows the saddle rack to pivot and supports ambidextrous operation.

A number of built-in safety features help to prevent theft of the container and items stored within the container. Firstly, a ring provides for attaching the container to an external fixed body, such as a lamp post. Secondly, a lock on the container prevents access to items in the container. This lock may be operated, for example, by a mechanical key or other coded electronic keys. The lock may also be operated remotely to lock or unlock the container. Finally, an integrated alarm system responding to container movements such as a shock or a tilt helps to prevent third parties from attempting to manoeuvre or access the container.

Further modifications and improvements may be incorporated without departing from the scope of the invention as defined by the appended claims.

1-40. (canceled)

41. A saddle rack, comprising:
a base; and
at least one storage compartment for containing equestrian equipment, characterised in that the saddle rack comprises suction cups for attachment of the base to an attachment surface.

42. A saddle rack as claimed in claim 41, wherein the suction cups are operated via a quick-release lever mechanism.

43. A saddle rack as claimed in claim 41, wherein the suction cups allow rotation of the saddle rack relative to the attachment surface.

44. A saddle rack as claimed in claim 41, wherein the saddle rack is constructed from a composite material.

45. A saddle rack as claimed in claim 41, wherein the saddle rack has an anatomic form.

46. A saddle rack as claimed in claim 45, wherein the anatomic form is that of the saddle bearing part of the back of a horse.

47. A system for storing equestrian equipment, the system comprising:
a saddle rack as claimed in claim 41, and
a container adapted to receive the saddle rack, wherein the container provides the attachment surface for attachment of the base of the saddle rack thereto.

48. A system as claimed in claim 47, wherein the container provides a first attachment point on an inner surface of the container, and a second attachment point on an outer surface of the container.

49. A system as claimed in claim 47, wherein the container comprises a main body and lid.

50. A system as claimed in claim 49, wherein the lid is attached to the container main body by hinges and is supported by gas-assisted struts.

51. A system as claimed in claim 47, wherein the container has security means.

52. A system as claimed in claim 51, wherein the security means is a code lock device.

53. A system as claimed in claim 51, wherein the security means includes a micro chip identification device.

54. A system as claimed in claim 51, wherein the security means includes a ring for attaching a security lanyard.

55. A system as claimed in claim 51, wherein the security means incorporates an alarm system.

56. A system as claimed in claim 47, wherein the container has handling means, wherein the handling means includes a wheeled trolley.

57. A system as claimed in claim 56, wherein the container is provided with second attachment means for attaching the trolley to the container.

58. A system as claimed in claim 47, wherein the container defines a storage space adapted to contain a plurality of saddle racks.

59. A system as claimed in claim 58, wherein said storage space has dimensions sufficient to encapsulate at least one saddle and other horse tack.
